(19) United States
(12) Patent Application Publication
(10) Pub. No.: US 2019/0058363 A1
(43) Pub. Date: Feb. 21, 2019

(54) WIRELESS CHARGING SYSTEM AND CONTROL METHOD THEREOF

(71) Applicant: BOE TECHNOLOGY GROUP CO., LTD., Beijing (CN)

(72) Inventor: Litong HAN, Beijing (CN)

(21) Appl. No.: 15/914,132

(22) Filed: Mar. 7, 2018

(30) Foreign Application Priority Data
Aug. 21, 2017 (CN) 201710718697.X

(51) Int. Cl. H02J 50/90; H02J 7/02; H02J 50/40; H02J 50/80; H02J 7/00

(52) U.S. Cl. CPC H02J 50/90; H02J 7/025; H02J 7/0013; H02J 50/80; H02J 50/40

(57) ABSTRACT

A wireless charging system includes: a charging device, including a plurality of wireless charging transmitters configured to transmit energy; and a terminal device, including a plurality of wireless charging receivers configured to receive the energy, and a control circuit; the plurality of wireless charging receivers being provided at different positions of the terminal device and respectively facing the plurality of wireless charging transmitters, the control circuit being configured to control the wireless charging receiver to receive energy from the wireless charging transmitter, wherein the wireless charging receiver includes a temperature sensor and a switch controller, the control circuit being connected to both the temperature sensor and the switch controller.

### CROSS REFERENCE

The present application claims the priority of Chinese Patent Application No. 201710718697.X, entitled “wireless charging system and control method thereof”, filed on Aug. 21, 2017, and the entire contents thereof are incorporated herein by reference.

### TECHNICAL FIELD

The present disclosure relates to the field of wireless charging technology, and in particular, to a wireless charging system and a control method thereof.

### BACKGROUND

In recent years, wireless charging technology or non-contact charging technology has been implemented in a variety of home electronic devices, and its convenience has received warm welcome from consumers. For example, some existing smart phone devices have a built-in wireless charging receiving coil, and wireless charging may be conveniently achieved through a matched wireless charging base.

However, so far, the wireless charging technology is still limited by following matters. Firstly, it is a directionality problem of the wireless charging. An existing wireless charging system has quite strict requirements on a placing manner of the terminal device unless a resonant coil whose orientation is changeable is used. Secondly, it is a power problem of the wireless charging. Due to limitation of existing wireless charging protocols such as a physical layer and a protocol layer and consideration of security, power of the wireless charging is low. Finally, it is a heating problem of a device caused by a long time period of the wireless charging and other issues. The terminal device cannot be wirelessly charged continuously, which also causes that the wireless charging power cannot be effectively improved.

It should be noted that, information disclosed in the above background portion is provided only for better understanding of the background of the present disclosure, and thus it may contain information that does not constitute the prior art known by those ordinary skilled in the art.

### SUMMARY

Other features and advantages of the present disclosure will be apparent from the following detailed description, or may be partly learned by practice of the present disclosure.

According to an aspect of the present disclosure, there is provided a wireless charging system, including:

a charging device, including a plurality of wireless charging transmitters configured to transmit energy; and

a terminal device, including a plurality of wireless charging receivers configured to receive the energy, and a control circuit; the plurality of wireless charging receivers being provided at different positions of the terminal device and respectively facing the plurality of wireless charging transmitters, the control circuit being configured to control the wireless charging receiver to receive energy from the wireless charging transmitter,

wherein the wireless charging receiver includes a temperature sensor and a switch controller, the control circuit being connected to both the temperature sensor and the switch controller.

In an exemplary embodiment of the present disclosure, the plurality of wireless charging receivers are respectively provided on a bezel and/or a back plate of the terminal device.

In an exemplary embodiment of the present disclosure, the plurality of wireless charging receivers include a first group of wireless charging receivers and a second group of wireless charging receivers that operate alternately.

In an exemplary embodiment of the present disclosure, the first group of wireless charging receivers are provided on the bezel and spaced apart from one another, and the second group of wireless charging receivers are provided on the back plate and spaced apart from one another,

wherein orthographic projection positions of the wireless charging receivers provided on the bezel on the back plate and the wireless charging receivers provided on back plate on the back plate alternate with each other.

In an exemplary embodiment of the present disclosure, the plurality of wireless charging transmitters and the plurality of wireless charging receivers are in one-to-one correspondence; or,

each of the wireless charging transmitters corresponds to one of the first group of wireless charging receivers and one of the second group of wireless charging receivers, and two wireless charging receivers corresponding to the same wireless charging transmitter are adjacent to each other.

In an exemplary embodiment of the present disclosure, the terminal device further includes:

a plurality of capacitors, each of the wireless charging receivers is connected in parallel with one of the capacitors,

wherein the capacitor is configured such that its capacitance maintains quantity of electric charge required for switching between the first group of wireless charging receivers and the second group of wireless charging receivers.

In an exemplary embodiment of the present disclosure, the control circuit includes:

a receiver, configured to receive a temperature detected by the temperature sensor; and

a first control circuit, configured to control the corresponding switch controller to adjust an operating state of the wireless charging receiver according to the received temperature.

In an exemplary embodiment of the present disclosure, the control circuit further includes:

a storage, configured to store the received temperature data of each of the wireless charging receivers;

an analyzer, configured to analyze a temperature change trend of each of the wireless charging receivers according to the temperature data to obtain heat dissipation data;

and

a second control circuit, configured to dynamically adjust an operating amount of the wireless charging receivers at different positions or a transmitting power of the wireless charging transmitters corresponding to the wireless charging receivers according to the heat dissipation data.

In an exemplary embodiment of the present disclosure, each of the charging device and the terminal device includes:

a wireless information transceiver unit, configured to, when a temperature of any of the wireless charging receivers exceeds a threshold temperature, transmit a wireless signal for turning off the corresponding wireless charging transmitter.

In an exemplary embodiment of the present disclosure, the terminal device further includes an energy storage element,

wherein the energy storage element is constituted by a plurality of batteries connected in parallel, and each of the batteries correspondingly receives an electric power output by one of the wireless charging receivers; or

the energy storage element is constituted by a plurality of batteries connected in series, and all the batteries simultaneously receive an electric power output by the plurality of wireless charging receivers.

According to an aspect of the present disclosure, there is provided a method for controlling a wireless charging system, for controlling the wireless charging system described above, wherein the control method includes:

a plurality of wireless charging transmitters of a charging device transmitting energy to a terminal device; and

a control circuit of the terminal device controlling the plurality of wireless charging receivers of the terminal device to receive the energy, and the plurality of wireless charging receivers respectively facing the plurality of wireless charging transmitters at different positions,

wherein the control circuit is connected to both a temperature sensor and a switch controller in the wireless charging receiver.

In an exemplary embodiment of the present disclosure, the control circuit of the terminal device controlling the plurality of wireless charging receivers of the terminal device to receive the energy includes:

dividing the plurality of wireless charging receivers into a first group of wireless charging receivers and a second group of wireless charging receivers;

the control circuit setting the first group of wireless charging receivers to an operating state and setting the second group of wireless charging receivers to a non-operating state;

the wireless charging transmitter driving the first group of wireless charging receivers to receive energy input with a maximum power; and

when a temperature of the first group of wireless charging receivers reaches a threshold temperature, the control circuit switching the first group of wireless charging receivers to the non-operating state and simultaneously switching the second group of wireless charging receivers to the operating state.

In an exemplary embodiment of the present disclosure, the control method further includes:

each of the wireless charging receivers being connected in parallel with a capacitor, when an operating state of one of the wireless charging receivers is switched, the capacitor releasing its quantity of electric charge to maintain a stable operation of the terminal device, until a next group of the wireless charging receivers is in the operating state.

In an exemplary embodiment of the present disclosure, the control method further includes:

the control circuit receiving temperature data of each of the wireless charging receivers from the temperature sensor;

analyzing a temperature change trend of each of the wireless charging receivers according to the temperature data to obtain heat dissipation data; and

dynamically adjusting an operating amount of the wireless charging receivers at different positions or dynamically adjusting transmitting power of the wireless charging transmitters corresponding to the wireless charging receivers according to the heat dissipation data.

In an exemplary embodiment of the present disclosure, the control method further includes:

when a temperature of any of the wireless charging receivers exceeds a threshold temperature, transmitting a wireless signal for turning off the corresponding wireless charging transmitter to a wireless information transceiver unit provided on the charging device through a wireless information transceiver unit provided on the terminal device.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Apparently, the accompanying drawings in the following description show merely some embodiments of the present disclosure, and those skilled in the art may still derive other drawings from these accompanying drawings without creative labor.

FIG. 1 schematically shows a first block schematic diagram of a wireless charging system in an exemplary embodiment of the present disclosure;

FIG. 2 schematically shows a first schematic diagram of a disposition location of wireless charging receivers of a touch panel in the prior art;

FIG. 3 schematically shows a second schematic diagram of a disposition location of wireless charging receivers in an exemplary embodiment of the present disclosure;

FIG. 4 schematically shows a second block schematic diagram of a wireless charging system in an exemplary embodiment of the present disclosure; and

FIG. 5 schematically shows a flowchart of a method for controlling a wireless charging system in an exemplary embodiment of the present disclosure.

### DETAILED DESCRIPTION

Example embodiments will now be described more fully with reference to the accompanying drawings. However, the example embodiments may be embodied in many forms and should not be construed as limited to the embodiments set forth herein; rather, the embodiments are provided so that the present disclosure will be thorough and complete, and will fully convey the concept of the exemplary embodiments to those skilled in the art. The features, structures, or characteristics described herein may be combined in any suitable manner in one or more embodiments. In the following description, numerous specific details are given to provide a thorough understanding of embodiments of the present disclosure. However, those skilled in the art will recognize that the technical solutions of the present disclosure may be practiced without one or more of the specific details, or may adopt other methods, components, apparatuses, steps and the like. In other instances, well-known solutions may not be shown or described in detail to avoid obscuring aspects of the present disclosure.

For ease of description, terms of special relationship such as “below”, “under”, “underneath”, “above”, “over” or the like are used herein to describe the relationship of an element or a feature with another element or feature (or other elements or features). It should be understood that, the terms of special relationship are intended to encompass different orientations of the apparatus in use or in operation in addition to the orientations shown in the figures. For example, if the device in the figures is turned over, elements described as “below” or “under” the other elements or features would then be “above” other elements or features. Thus, the exemplary terms “below” may include the orientation of both “above” and “below”. The device may be otherwise orientated (rotated 90 degrees or at other orientations) and spatially relationship descriptors used herein are interpreted accordingly.

In addition, the drawings are merely schematic representations of the present disclosure and are not necessarily drawn to scale. The thickness and shape of each layer in the drawings do not reflect the true scale, but are for the purpose of illustration of the present disclosure only. The same reference numeral in the drawings denotes the same or similar part, and a repetitive description thereof will be omitted.

In the following, the term “wireless charging” describes a technical solution for charging a charging device and a terminal device without wire connection. For example, the wireless charging between the charging device and the terminal device may be achieved by electromagnetic induction charging, magnetic resonance charging, and microwave resonance or the like. In the electromagnetic induction charging, the charging device and the terminal device are respectively provided with a coil. An alternating magnetic field is generated by an alternating current, and a magnetic field is induced in a coil of the terminal device to generate a current. In the magnetic resonance charging, the charging device and the terminal device are respectively provided with a coil with a matching specification, a magnetic field is generated after the coil of the charging device is powered on, and the coil of the terminal device is resonated and converted into a current. In the microwave resonance, the charging device transmits a microwave to serve as a transmission signal of energy, and the terminal device receives the microwave and restores the microwave to the current through a resonance circuit and a rectification circuit. Other solutions, such as the electromagnetic coupling may also be applied to the technical solution of the present disclosure.

The present exemplary embodiment provides a wireless charging system. As shown in FIG. 1, the wireless charging system may include: a charging device 10 and a terminal device 20.

The charging device 10 includes a plurality of wireless charging transmitters 100 and a power connection line. The power connection line is configured to connect the charging device 10 to an electric power circuit. The wireless charging transmitter 100 is configured to transmit energy.

The terminal device 20 includes a plurality of wireless charging receivers 201 configured to receive the energy, and a control circuit 202. The plurality of wireless charging receivers 201 are provided at different positions of the terminal device 20 and respectively facing the plurality of wireless charging transmitters 100. The control circuit 202 is configured to control the wireless charging receiver 201 to receive energy from the wireless charging transmitter 100.

In the embodiment, the wireless charging receiver 201 may include a temperature sensor 203 and a switch controller 204. The control circuit 202 is connected to both the temperature sensor 203 and the switch controller 204. The specific connection manner may be wireless connection or wired connection, as long as it may achieve communication of information.

It should be noted that, the energy transmitted between the wireless charging transmitter 100 and the wireless charging receiver 201 in the present embodiment includes but is not limited to electric energy and it may also be other forms of energy, such as microwaves. In addition, one or more terminal devices 20 may be included in the wireless charging system at the same time. That is, during the wireless charging process, the charging device 10 may provide electric power to one or more terminal devices 20 at the same time.

According to the wireless charging system provided by the exemplary embodiment of the present disclosure, a plurality of wireless charging transmitters 100 disposed at different positions of the charging device 10 are used to provide energy to a plurality of wireless charging receivers 201 of the terminal device 20, to implement wireless charging of the terminal device 20. On one hand, this wireless charging manner may effectively improve the directionality problem of the wireless charging, so as to improve convenience of the wireless charging. On the other hand, since the plurality of wireless charging receivers 201 may be charged at the same time, the power of the wireless charging may be significantly improved, so as to provide a basis for achieving the high-power wireless charging. On another hand, a temperature of each wireless charging receiver 201 is detected by using the temperature sensor 203. In this way, when the temperature of a wireless charging receiver 201 is too high, the control circuit 202 may control its switch controller 204 to turn off the corresponding wireless charging receiver 201, thereby decreasing the heating phenomenon of the device, which is beneficial to improving safety of the wireless charging.

In the present exemplary embodiment, the terminal device 20 may include, for example, electronic devices such as a mobile phone, a tablet computer, a television, a notebook computer, an electronic picture frame, a navigator, and the like.

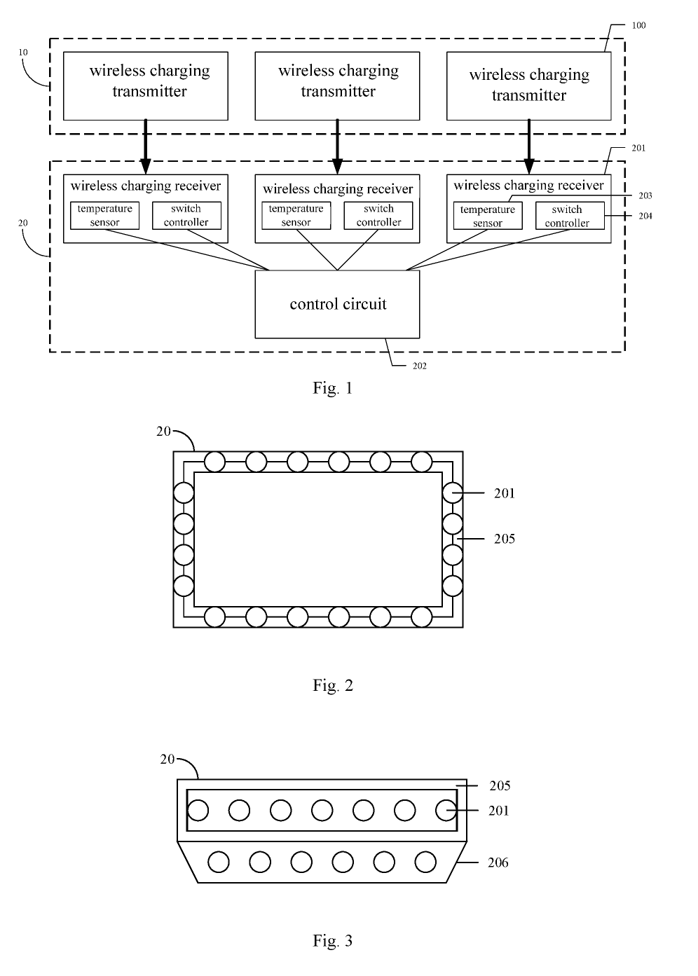

In the present exemplary embodiment, as shown in FIGS. 2 and 3, the plurality of wireless charging receivers 201 may be respectively provided on a bezel 205 and/or a back plate 206 of the terminal device 20. In consideration of the heat dissipation problem of the device, some of the plurality of wireless charging receivers 201 may be disposed on the bezel 205 of the terminal device 20 and others are disposed on the back plate 206 of the terminal device 20. In the embodiment, the orthographic projection position of the wireless charging receivers 201 on the bezel 205 on the back plate 206 and may alternate with that of the wireless charging receivers 201 on back plate 206 on the back plate 206.

For example, as shown in FIG. 3, the plurality of wireless charging receivers 201 may be disposed in a manner that the plurality of wireless charging receivers 201 are alternately arranged on the bezel 205 and the back plate 206. For example, wireless charging receivers 201 with odd-numbered coordinate positions such as 1, 3, 5, 7, 9 and the like are sequentially deployed on the bezel 205, while wireless charging receivers 201 with even-numbered coordinate positions such as 2, 4, 6, 8, 10 and the like are sequentially deployed on the back plate 206. In this way, the wireless charging receivers 201 provided on the back plate 206 are not adjacent to those provided on the bezel 205, the wireless charging receivers 201 provided on the back plate 206 are not adjacent to each other, and the two wireless charging receivers 201 in adjacent positions are respectively located on the bezel 205 and the back plate 206, thereby facilitating the heat dissipation of the terminal device 20 and avoiding the device from being damaged due to overheating.

It should be noted that, the adjacent relationship in this example is described from the perspective of the odd coordinate position and the even coordinate position. Therefore, the wireless charging receivers 201 on the bezel 205 are spaced apart from one another, and the wireless charging receivers 201 on the back plate 206 are also spaced apart from one another.

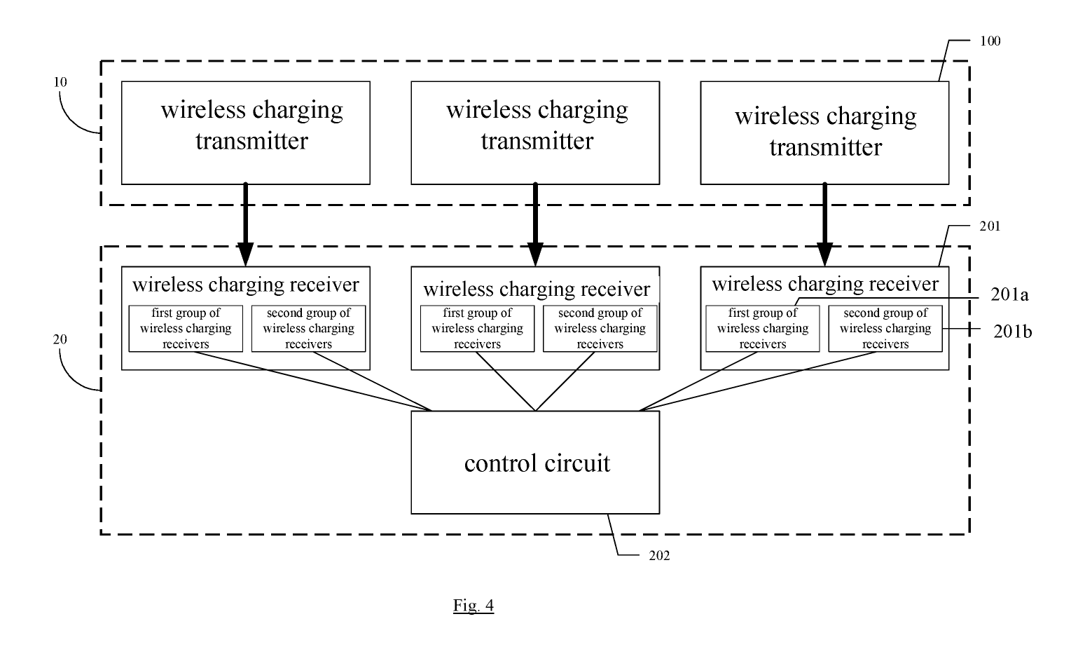

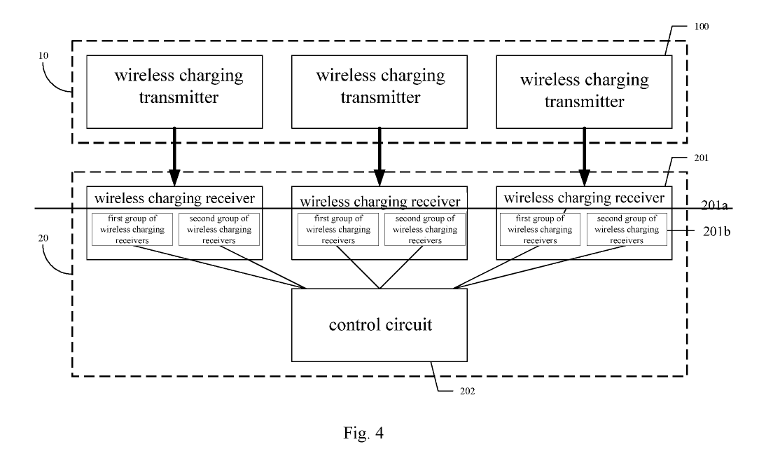

In consideration of the heating problem during the high-power wireless charging, as shown in FIG. 4, in the present exemplary embodiment, the plurality of wireless charging receivers 201 is be classified as a first group of wireless charging receivers 201a and a second group of wireless charging receivers 201b that operate alternately. That is, only some of all the wireless charging receivers 201 of the terminal device 20 are in an operating state while others are in a non-operating state.

For example, when the first group of wireless charging receivers 201a operate, the wireless charging transmitter 100 may drive the first group of wireless charging receivers 201a with a maximum power to receive energy inputs, and the second group of wireless charging receivers 201b is in the non-operating state at the same time. When the first group of wireless charging receivers 201a reaches a heating threshold due to the high-power wireless charging, the control circuit 202 may switch the second group of wireless charging receivers 201b from the non-operating state to the operating state, to enable the second group of wireless charging receivers 201b to receive the wireless charging, and simultaneously switch the first group of wireless charging receivers 201a from the operating state to the non-operating state, to enable the first group of wireless charging receivers 201a to cool and dissipate heat. As a result, through the continuously alternative operating manner, it may not only achieve the continuous high-power charging, but also avoid the risk of damaging the device due to overheating.

On this basis, in the present embodiment, the first group of wireless charging receivers 201a is provided on the bezel 205 of the terminal device 20 and spaced apart from one another, and the second group of wireless charging receivers 201b is provided on the back plate 206 of the terminal device 20 and spaced apart from one another. In this way, in combination with the arrangement manner shown in FIG. 3, on the back plate 206, the orthographic projection position of the wireless charging receivers 201 on the bezel 205 may alternate with that of the wireless charging receivers 201 on back plate 206, so that the closest wireless charging receivers 201 in the operating state are separated by a certain distance, to avoid overheating phenomenon to the maximum extent.

Further, referring to FIG. 4, in consideration of the simplification of the circuit design, in the present exemplary embodiment, each wireless charging transmitter 100 may correspond to two adjacent wireless charging receivers 201, and one of the two adjacent wireless charging receivers is included in the first group of wireless charging receivers 201a disposed on the bezel 205 and the other one is included in the second group of wireless charging receivers 201b disposed on the back plate 206. Alternatively, as shown in FIG. 1, in the exemplary embodiment, the wireless charging transmitters 100 and the wireless charging receivers 201 may also be in one-to-one correspondence. That is, one wireless charging transmitter 100 corresponds to one wireless charging receiver 201. The wireless charging transmitter 100 and the wireless charging receiver 201 may also be configured in other correspondences. For example, one wireless charging transmitter 100 corresponds to several of the first group of wireless charging receivers 201a and several of the second group of wireless charging receivers 201b, which will not be listed one by one herein.

In the wireless charging system provided by this example embodiment, the terminal device 20 may include an energy storage element, such as a battery. In the embodiment, the energy storage element may be constituted by a plurality of batteries connected in parallel, and each of the batteries correspondingly receives an electric power output by one of the wireless charging receivers 201. Alternatively, the energy storage element may also be constituted by a plurality of batteries connected in series, and all the batteries simultaneously receive an electric power output by the plurality of wireless charging receivers 201 at a large current. In consideration of the characteristics of the lithium battery used in the electronic device, in this embodiment, it is preferable to store energy by using a plurality of batteries in parallel.

The wireless charging system provided in this exemplary embodiment may also be applicable to the case where the energy is directly provided to the terminal device 20. For example, the terminal device 20 is an electronic frame or the like which does not need to be moved. In this case, in order to ensure that the operating current of the wireless charging receivers 201 in different states do not fluctuate frequently during the switching, each wireless charging receiver 201 may further be connected in parallel with one capacitor, and the capacitance of the capacitor is large enough to maintain quantity of electric charge required for switching between the first group of wireless charging receivers 201a and the second group of wireless charging receivers 202b.

In this way, when the wireless charging receiver 201 provides the operating current for the terminal device 20, the parallel capacitor may be charged to obtain the required capacitance. The capacitance corresponds to the time required for different groups of wireless charging receivers 201 to switch. When switching is performed between different groups of wireless charging receivers 201, the parallel capacitor releases its quantity of electric charge to maintain a stable operation of the terminal device 20, until a next group of the wireless charging receivers 201 enters the operating state, thereby ensuring that the terminal device 20 is always in a stable operating current state.

Based on the above wireless charging system, the control circuit 202 of the terminal device 20 may include:

a receiver, configured to receive a temperature detected by the temperature sensor 203;

a first control circuit, configured to control the corresponding switch controller 204 to adjust an operating state of the wireless charging receiver 201 according to the received temperature;

a storage, configured to store the received temperature data of each of the wireless charging receivers 201;

an analyzer, configured to analyze a temperature change trend of each of the wireless charging receivers 201 according to the temperature data to obtain heat dissipation data; and

a second control circuit, configured to dynamically adjust an operating amount of the wireless charging receivers 201 at different positions or a transmitting power of the wireless charging transmitters 100 corresponding to the wireless charging receivers 201 according to the heat dissipation data.

For example, in the process of wireless charging, the temperature sensor 203 corresponding to one wireless charging receiver 201 detects the real-time temperature of the wireless charging receiver 201 and feeds it back to the control circuit 202. When the temperature of the wireless charging receiver 201 is too high due to charging in a large power for a long time period, the first control circuit of the control circuit 202 controls the switch controller 204 corresponding to the wireless charging receiver 201 to turn off the wireless charging receiver 201 according to the received temperature, thus preventing overheating phenomenon. On the basis of this, the storage of the control circuit 202 collects and stores the long-term temperature data of each wireless charging receiver 201 and analyzes the temperature change trend of each group by the analyzer to obtain the corresponding heat dissipation data. In this way, it may be perceived that the heat dissipation capability of different locations may be different due to the limitation of the installation environment of the terminal device 20. On basis of this, the second control circuit of the control circuit 202 dynamically adjusts an operating amount of the wireless charging receivers 201 on the bezel 205 or the back plate 206 or dynamically adjusts a transmitting power of the wireless charging transmitters 100 corresponding to the wireless charging receivers 201, thus achieving the wireless charging more effectively.

In this example embodiment, each of the charging device 10 and the terminal device 20 may include a wireless information transceiver unit. When a temperature of the wireless charging receiver 201 exceeds a threshold temperature, the terminal device 20 may transmit a wireless signal for turning off the corresponding wireless charging transmitter 100 to the charging device 10 through the wireless information transceiver unit, so as to reduce unnecessary power consumption. In the present embodiment, the wireless information transceiver unit may be implemented by means of Wi-Fi (Wireless Fidelity), Bluetooth, or zigbee. Based on anti-interference considerations, zigbee is preferably used in this embodiment.

It should be noted that, the wireless charging system provided in this exemplary embodiment is not limited to the used charging protocol and the used charging mode. For example, the electromagnetic induction type, the radio wave type, the magnetic field resonance type and the like are all possible. The magnetic field resonance type is preferred, since it may provide a greater wireless charging power and a longer charging distance.

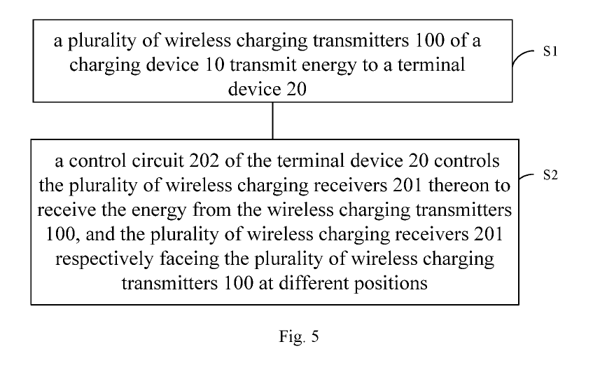

The exemplary embodiment further provides a method for controlling a wireless charging system, for controlling the above wireless charging system. As shown in FIG. 5, the control method may include following steps.

S1, a plurality of wireless charging transmitters 100 of a charging device 10 transmits energy to a terminal device 20.

S2, a control circuit 202 of the terminal device 20 controls the plurality of wireless charging receivers 201 thereon to receive the energy from the wireless charging transmitters 100, and the plurality of wireless charging receivers 201 respectively faces the plurality of wireless charging transmitters 100 at different positions.

In the embodiment, the control circuit is connected to both a temperature sensor 203 and a switch controller 204 in the wireless charging receiver 201. The connection manner may be wireless connection or wired connection, as long as it may achieve communication of information.

According to the method for controlling a wireless charging system provided by the exemplary embodiment of the present disclosure, a plurality of wireless charging transmitters 100 disposed at different positions of the charging device 10 are used to provide energy to a plurality of wireless charging receivers 201 of the terminal device 20, to implement wireless charging of the terminal device 20. On one hand, this wireless charging manner may effectively improve the directionality problem of the wireless charging, so as to improve convenience of the wireless charging. On the other hand, since the plurality of wireless charging receivers 201 is charged at the same time, the power of the wireless charging may be significantly improved, so as to provide a basis for achieving the high-power wireless charging. On another hand, a temperature of each wireless charging receiver 201 is detected by using the temperature sensor 203. In this way, when the temperature of a wireless charging receiver 201 is too high, the control circuit 202 may control its switch controller 204 to turn off the corresponding wireless charging receiver 201, thereby improving the heating phenomenon of the device, which is beneficial to improving safety of the wireless charging.

The method for controlling the wireless charging system in the present exemplary embodiment will be described in detail below.

In step S1, a plurality of wireless charging transmitters 100 of a charging device 10 transmits energy to a terminal device 20.

In the embodiment, the charging device 10 may transmit energy to one or more terminal devices 20 at the same time. The number of terminal devices 20 that access the system is not limited in the present embodiment, but in order to maintain a high charging power, each terminal device 20 should at least correspondingly receive the electrical power transmitted by, for example, 3-5 wireless charging transmitters 100.

In the present embodiment, the energy transmitted between the charging device 10 and the terminal device 20 includes but is not limited to electric energy and it may also be other forms of energy, such as microwaves.

In step S2, a control circuit 202 of the terminal device 20 controls the plurality of wireless charging receivers 201 thereon to receive the energy from the wireless charging transmitters 100, and the plurality of wireless charging receivers 201 respectively faces the plurality of wireless charging transmitters 100 at different positions.

In the embodiment, the step S2 may specifically include following sub-steps.

S21, the plurality of wireless charging receivers 201 is divided into a first group of wireless charging receivers 201a and a second group of wireless charging receivers 201b.

S21, the control circuit 202 sets the first group of wireless charging receivers 201a to an operating state and sets the second group of wireless charging receivers 201b to a non-operating state.

S23, the wireless charging transmitter 100 drives the first group of wireless charging receivers 201a to receive energy input with a maximum power.

S24, when a temperature of the first group of wireless charging receivers 201a reaches a threshold temperature, the control circuit 202 switches the first group of wireless charging receivers 201a to the non-operating state for heat dissipation and simultaneously switches the second group of wireless charging receivers 201b to the operating state for receiving the electric power input.

Based on this, through the continuously alternative operating manner, it may not only achieve the continuous high-power charging, but also avoid the phenomenon of damaging the device due to overheating.

In this example embodiment, in consideration of heat dissipation problem of the terminal device 20, the first group of wireless charging receivers 201a may be disposed on the bezel 205 with intervals, and the second group of wireless charging receivers 201b may be disposed on the back plate 206 with intervals, and orthographic projection positions of the first group of wireless charging receivers 201a and the second group of wireless charging receivers 201b on back plate 206 alternate with each other. With this arrangement manner, the closest wireless charging receivers 201 in the operating state are separated by a certain distance, to avoid overheating phenomenon to the maximum extent.

When the wireless charging system provides energy for a terminal device 20, for example an electronic picture frame, which does not be provided with an energy storage element, each of the wireless charging receivers 201 may also be connected in parallel with a capacitor. When an operating state of the wireless charging receivers 201 of a different group needs to be switched, the capacitor connected in parallel may release its quantity of electric charge to maintain a stable operation of the terminal device 20, until a next group of the wireless charging receivers 201 is in the operating state, thus effectively avoiding that the operating current fluctuates frequently caused by the switching of the wireless charging receivers 201, thereby ensuring that the terminal device 20 is always in a stable operating current state.

In this example embodiment, when the temperature sensor 203 detects that the temperature of any wireless charging receiver 201 is too high, the control circuit 202 may control the corresponding switch controller 204 to turn off the wireless charging receiver 201. Similarly, when a cooled wireless charging receiver 201 needs to be switched from the non-operating state to the operating state, the control circuit 202 may control the corresponding switch controller 204 to turn on the wireless charging receiver 201.

It should be noted that, if the wireless charging receiver 201 performs wireless charging in a grouping manner, that is, the first group of wireless charging receivers 201a and the second group of wireless charging receivers 201b collectively correspond to a wireless charging transmitter 100, then, when one wireless charging receiver 201 is turned off, the other wireless charging receiver 201 paired with it may be turned on at the same time; if the wireless charging receiver 201 is in one-to-one correspondence with the wireless charging transmitter 100, the wireless charging receiver 201 may be directly turned off.

Based on the foregoing steps S1 and S2, in order to more effectively implement the wireless charging, the method for controlling the wireless charging system may further include:

S31, the control circuit 202 receiving temperature data of each of the wireless charging receivers 201 from the temperature sensor 203;

S31, analyzing a temperature change trend of each of the wireless charging receivers 201 according to the temperature data to obtain heat dissipation data; and

S33, dynamically adjusting an operating amount of the wireless charging receivers 201 at different positions or dynamically adjusting transmitting power of the wireless charging transmitters 100 corresponding to the wireless charging receivers 201 according to the heat dissipation data.

In this way, the control circuit 202 may analyze the temperature change trend of each wireless charging receiver 201, so as to perceive that the heat dissipation capability of different locations may be different due to the limitation of the installation environment of the terminal device 20, and on basis of this, the control circuit 202 dynamically adjusts an operating amount of the wireless charging receivers 201 on the bezel 205 or the back plate 206 or dynamically adjusts a transmitting power of the wireless charging transmitters 100 corresponding to the wireless charging receivers 201, thus achieving the wireless charging more effectively.

Based on the above steps, the control method in this example embodiment may further include:

S4, when a temperature of any of the wireless charging receivers 201 exceeds a threshold temperature, transmitting a wireless signal for turning off the corresponding wireless charging transmitter 100 to a wireless information transceiver unit provided on the charging device 10 through a wireless information transceiver unit provided on the terminal device 20.

In the present embodiment, the wireless information transceiver unit may be implemented by means of Wi-Fi (Wireless Fidelity), Bluetooth, or zigbee. Based on anti-interference considerations, zigbee is preferably used in this embodiment.

It should be noted that, the wireless charging system provided in this exemplary embodiment is not limited to the used charging protocol and the used charging mode. For example, the electromagnetic induction type, the radio wave type, the magnetic field resonance type and the like are all possible. The magnetic field resonance type is preferred, since it may provide a greater wireless charging power and a longer charging distance.

Other embodiments of the present disclosure will readily occur to those skilled in the art upon consideration of the specification and practice of the disclosure disclosed herein. The present application is intended to cover any variation, use, or adaptation of the present disclosure that follows general principles of the present disclosure and includes common knowledge or conventional technical means in the art which are not disclosed herein. The specification and embodiments are considered as exemplary only, with the true scope and spirit of the present disclosure being indicated by the appending claims.

It should be understood that the present disclosure is not limited to the precise structures that have been described above and shown in the drawings, and that various modifications and changes may be made without departing from the scope thereof. The scope of the disclosure is limited only by the accompanying claims.

What is claimed is:

1. A wireless charging system, comprising:
a charging device, comprising a plurality of wireless charging transmitters configured to transmit energy; and
a terminal device, comprising a plurality of wireless charging receivers configured to receive the energy, and a control circuit; the plurality of wireless charging receivers being provided at different positions of the terminal device and respectively facing the plurality of wireless charging transmitters, the control circuit being configured to control the wireless charging receiver to receive energy from the wireless charging transmitter,
wherein the wireless charging receiver comprises a temperature sensor and a switch controller, the control circuit is connected to both the temperature sensor and the switch controller.

2. The wireless charging system according to claim 1, wherein the plurality of wireless charging receivers are respectively provided on a bezel and/or a back plate of the terminal device.

3. The wireless charging system according to claim 1, wherein the plurality of wireless charging receivers comprise a first group of wireless charging receivers and a second group of wireless charging receivers that operate alternately.

4. The wireless charging system according to claim 3, wherein the first group of wireless charging receivers is provided on the bezel and the wireless charging receivers in the first group are spaced apart from one another, and the second group of wireless charging receivers is provided on the back plate and the wireless charging receivers in the second group are spaced apart from one another,
wherein a position where the wireless charging receivers provided on the bezel is orthographically projected on the back plate alternates with a position where the wireless charging receivers provided on back plate is orthographically projected on the back.

5. The wireless charging system according to claim 3, wherein the plurality of wireless charging transmitters and the plurality of wireless charging receivers are in one-to-one correspondence.

6. The wireless charging system according to claim 3, wherein each of the wireless charging transmitters corresponds to one of the first group of wireless charging receivers and one of the second group of wireless charging receivers, and two wireless charging receivers corresponding to the same wireless charging transmitter are adjacent to each other.

7. The wireless charging system according to claim 3, wherein the terminal device further comprises:
a plurality of capacitors, wherein each of the wireless charging receivers is connected in parallel with one of the capacitors,
wherein the capacitor is configured such that its capacitance maintains quantity of electric charge required for switching between the first group of wireless charging receivers and the second group of wireless charging receivers.

8. The wireless charging system according to claim 1, wherein the control circuit comprises:
a receiver, configured to receive a temperature detected by the temperature sensor; and
a first control circuit, configured to control the corresponding switch controller to adjust an operating state of the wireless charging receiver according to the received temperature.

9. The wireless charging system according to claim 8, wherein the control circuit further comprises:
a storage, configured to store the received temperature data of each of the wireless charging receivers;
an analyzer, configured to analyze a temperature change trend of each of the wireless charging receivers according to the temperature data to obtain heat dissipation data; and
a second control circuit, configured to dynamically adjust an operating amount of the wireless charging receivers at different positions or a transmitting power of the wireless charging transmitters corresponding to the wireless charging receivers according to the heat dissipation data.

10. The wireless charging system according to claim 1, wherein each of the charging device and the terminal device comprises:
a wireless information transceiver unit, configured to, when a temperature of any of the wireless charging receivers exceeds a threshold temperature, transmit a wireless signal for turning off the corresponding wireless charging transmitter.

11. The wireless charging system according to claim 2, wherein each of the charging device and the terminal device comprises:
a wireless information transceiver unit, configured to, when a temperature of any of the wireless charging receivers exceeds a threshold temperature, transmit a wireless signal for turning off the corresponding wireless charging transmitter.

12. The wireless charging system according to claim 3, wherein each of the charging device and the terminal device comprises:
a wireless information transceiver unit, configured to, when a temperature of any of the wireless charging receivers exceeds a threshold temperature, transmit a wireless signal for turning off the corresponding wireless charging transmitter.

13. The wireless charging system according to claim 1, wherein the terminal device further comprises an energy storage element,
wherein the energy storage element comprises a plurality of batteries connected in parallel, and each of the batteries correspondingly receives an electric power output by one of the wireless charging receivers.

14. The wireless charging system according to claim 1, wherein the terminal device further comprises an energy storage element,
wherein the energy storage element comprises a plurality of batteries connected in series, and all the batteries simultaneously receive an electric power output by the plurality of wireless charging receivers.

15. The wireless charging system according to claim 2, wherein the terminal device further comprises an energy storage element,
wherein the energy storage element comprises a plurality of batteries connected in parallel, and each of the batteries correspondingly receives an electric power output by one of the wireless charging receivers.

16. A method for controlling a wireless charging system, for controlling the wireless charging system according to claim 1, wherein the control method comprises:
a plurality of wireless charging transmitters of a charging device transmitting energy to a terminal device; and
a control circuit of the terminal device controlling the plurality of wireless charging receivers of the terminal device to receive the energy, and the plurality of wireless charging receivers respectively facing the plurality of wireless charging transmitters at different positions,
wherein the control circuit is connected to both a temperature sensor and a switch controller in the wireless charging receiver.

17. The method for controlling a wireless charging system according to claim 16, wherein the step of the control circuit of the terminal device controlling the plurality of wireless charging receivers of the terminal device to receive the energy comprises:
dividing the plurality of wireless charging receivers into a first group of wireless charging receivers and a second group of wireless charging receivers;
the control circuit setting the first group of wireless charging receivers to an operating state and setting the second group of wireless charging receivers to a non-operating state;
the wireless charging transmitter driving the first group of wireless charging receivers to receive energy input with a maximum power; and
when a temperature of the first group of wireless charging receivers reaches a threshold temperature, the control circuit switching the first group of wireless charging receivers to the non-operating state and simultaneously switching the second group of wireless charging receivers to the operating state.

18. The method for controlling a wireless charging system according to claim 17, further comprising:
each of the wireless charging receivers being connected in parallel with a capacitor, when an operating state of one of the wireless charging receivers is switched, the capacitor releasing its quantity of electric charge to maintain a stable operation of the terminal device, until a next group of the wireless charging receivers is in the operating state.

19. The method for controlling a wireless charging system according to claim 16, further comprising:
the control circuit receiving temperature data of each of the wireless charging receivers from the temperature sensor;
analyzing a temperature change trend of each of the wireless charging receivers according to the temperature data to obtain heat dissipation data; and
dynamically adjusting an operating amount of the wireless charging receivers at different positions or dynamically adjusting transmitting power of the wireless charging transmitters corresponding to the wireless charging receivers according to the heat dissipation data.

20. The method for controlling a wireless charging system according to claim 16, further comprising:
when a temperature of any of the wireless charging receivers exceeds a threshold temperature, transmitting a wireless signal for turning off the corresponding wireless charging transmitter to a wireless information transceiver unit provided on the charging device through a wireless information transceiver unit provided on the terminal device.
